(19) United States
(12) Patent Application Publication
(10) Pub. No.: US 2013/0220919 A1
(43) Pub. Date: Aug. 29, 2013

(54) Method for recovering phosphate salts from a liquid

(71) Applicants: Jennifer Bilbao, Stuttgart (DE); Dieter Bryniok, Dusslingen (DE); Siegfried Egner, Adelsheim (DE); Daniel Frank, Stuttgart (DE)

(72) Inventors: Jennifer Bilbao, Stuttgart (DE); Dieter Bryniok, Dusslingen (DE); Siegfried Egner, Adelsheim (DE); Daniel Frank, Stuttgart (DE)

(73) Assignee: Fraunhofer-Gesellschaft zur Foerderung der angewandten Forschung e. V., Muenchen (DE)

(21) Appl. No.: 13/883,579

(22) PCT Filed: Oct. 31, 2011
(86) PCT No.: PCT/EP11/69118

§ 371 Date: May 6, 2013

(30) Foreign Application Priority Data
Nov. 6, 2010 (DE) 10 2010 050 691.5

(51) Int. Cl. C02F 1/461

(52) U.S. Cl. CPC C02F 1/461
USPC 210/601; 205/742

(57) ABSTRACT

The invention relates to a method for completely separating phosphate from a liquid and for recovering phosphate salts in a reactor, which is equipped with two groups of electrodes having differing polarities, wherein the sacrificial electrodes consist of a magnesium-containing material, and wherein said method comprises the following method steps: the application of a voltage to the electrodes; the continuous flow of the liquid through the reactor; the precipitation of phosphate salts from the liquid; and the settling of the crystals in the cone-shaped bottom of the reactor. For a galvanic procedure, no voltage is applied to the electrodes.

The invention concerns a method for complete separation of phosphate from a liquid and recovery of phosphate salts in a reactor that is equipped with two groups of electrodes of different polarity, wherein the sacrificial electrodes are comprised of a magnesium-containing material.

Phosphate salts such as magnesium ammonium phosphate (in the following abbreviated as MAP) or potassium magnesium phosphate (in the following abbreviated as PMP) are high-value plant adjuvants for which there is high demand. The elements nitrogen, potassium, magnesium, and phosphate of which these plant adjuvants are composed are typically contained solid or liquid organic waste materials. While potassium, magnesium and other ions are present in the form of water-soluble cations, nitrogen and phosphate are predominantly bound to or in organic material or cell mass. Accordingly, a major proportion of nitrogen and phosphate are not available for the production of plant adjuvants. For this reason it is necessary to convert nitrogen and phosphate into their inorganic form that is suitable for precipitation.

The spontaneous precipitation of MAP or PMP is limited by the usually very low magnesium concentration in wastewater. Known is the addition of magnesium hydroxide, magnesium oxide or soluble magnesium salts for MAP precipitation. The disadvantage in this context is the bad solubility of the oxides as well as of the salt-like hydroxides. Upon addition of magnesium hydroxide or magnesium oxide in solid form, but also as a suspension, to the wastewater, these compounds dissolve only very slowly and with a minimal proportion. This has the result that it is necessary to continuously perform stirring or mixing which, however, causes extra expenditure in regard to technology and energy and thus also with respect to costs. Moreover, both compounds, because of their bad solubility, must be added in over-stoichiometric amounts because otherwise an incomplete precipitation of the desired plant adjuvants occurs and significant quantities of phosphate remain in the wastewater. When magnesium salts are beforehand transferred into a solution, the efficiency of the method decreases because of the dilution with water.

The optimal pH value for precipitation of MAP is at 9. Wastewater has usually pH values between 5 and 7. Therefore, for increasing the pH value, a base is added. The use of a soluble base, for example, sodium hydroxide, causes problems because of dilution of the wastewater. When using a base that is sparingly soluble, for example, magnesium hydroxide, the latter will hardly dissolve in water and the aforementioned disadvantages will occur.

A further possibility for adjusting a pH value that is favorable for precipitation is disclosed in DE 101 12 934 B4. The aeration of primary sludge mentioned therein with subsequent CO₂ stripping is however very energy-intensive and causes therefore high additional costs.

WO 00200101019735A1 discloses a method for removal of dissolved nitrogen and phosphate from the aqueous portion of liquid manure by means of electrochemical precipitation.

The method described therein requires relatively high electrical voltages and is therefore energy-intensive and cost-intensive. A disadvantage is also that nitrogen and phosphate that are present organically bound in the aqueous portion of the liquid manure cannot be removed by the disclosed method. As a result of this, this wastewater must therefore be subjected to a subsequent purification in a water treatment plant.

Moreover, in this method due to the use of aluminum-containing electrodes the plant poison aluminum will end up in the precipitated product. When this product is applied to the soil, aluminum can be released and plant growth can be affected negatively.

An electrochemical precipitation of MAP is disclosed in WO 2007/009749 A1. This method requires however the addition of ammonium hydroxide for reaching a pH value that is favorable for precipitation and is not suitable for the precipitation of other phosphate salts. Also, this method operates exclusively with supply of electrical current.

The invention has the object to provide a method by means of which phosphate-containing wastewater can be treated and supplied to further use. Moreover, the invention has the object to provide a method for obtaining phosphate salts as plant adjuvants that overcomes the aforementioned disadvantages of the prior art.

The object is solved according to the invention by a method for complete separation of phosphate from a liquid and recovery of phosphate salts in a reactor that is equipped with two groups of electrodes of different polarity, wherein the sacrificial electrodes are comprised of a magnesium-containing material, in which an electrical direct current is applied to the electrodes, the reactor is continuously flowed through with the liquid or suspension so that phosphate salts precipitate, the crystals grow and deposit in the conical bottom of the reactor and are removed.

The invention provides a method for obtaining phosphate salts as plant adjuvants from organic wastewater, in this connection, the phosphates contained in the wastewater and its solid components are completely removed so that the wastewater treated with the method according to the invention requires no further treatment in a water treatment plant.

Reaction equation for formation of MAP:

Mg¹⁺+NH₄⁺+PO₄³⁻+6H₂O->MgNH₄PO₄.6H₂O

Reaction equation for formation of PMP:

Mg²⁺+K⁺+PO₄³⁻+6H₂O->MgKPO₄.6H₂O

Reaction equation for release of magnesium:

Mg(s)->Mg₂⁺+2e⁻

Reaction equation for formation of hydroxide ions:

2H₂O+2e⁻->2OH⁻+H₂

Because of the chemical activity of magnesium in water, the method according to the invention requires for normal operation only very low current strengths below 1 A and low voltages below 1 V. The supply of current prevents deposits on the electrode which are not stable in the electrical field. Because of the minimal energy input, the costs for the operation of the device are very low.

This method is very simple with respect to its operation, progresses very stably, and, moreover, requires no use of dangerous or aggressive chemicals.

An advantageous embodiment of the method according to the invention provides that the reactor is operated electrolytically. By the process of magnesium release, in accordance with the above reaction equation, electrons are released. This means that the method requires no electrical current but even supplies current.

A further advantage of the method according to the invention resides in that for precipitation of the phosphate salts the required pH value is achieved by an electrochemical process. The high pH value which is required for precipitation of phosphate salts is not achieved by addition of dangerous or aggressive chemicals but is adjusted automatically by the formation of hydroxide ions (OH⁻) in accordance with the above reaction equation.

Accordingly, on the one hand, a dilution of the wastewater by addition of solutions is avoided. On the other hand, a high throughput can be achieved because the reaction is not limited by the bad solubility of the base added in the form of salts. Both facts lead to an advantageous increase of the efficiency and the conversion rate of the method according to the invention.

It is particularly beneficial when the reactor is flowed through vertically from top to bottom. In this way, the sedimentation rate of the precipitated phosphate salts is accelerated. This means that the reactor can be constructed of a smaller size for the same throughput.

In supplementing this, it is proposed that the crystals are separated in a filter from the liquid. Accordingly, in the reactor flowed through from top to bottom the precipitated phosphate salts can be removed together with the liquid from the reactor. Accordingly, additional fixtures or devices for separate solids removal are not required. Also, in case of the common removal of phosphate salts and purified wastewater, turbulent flow is generated in the conduit and prevents clogging of the conduit by the crystals.

Conversely, it is also beneficial when the reactor is flowed through vertically from the bottom to the top. This arrangement according to the invention has the advantage that an automatic separation of liquid that flows upwardly and precipitated salts that sink to the bottom takes place.

The method according to the invention operates also when an outflow of the reactor is returned to the inlet of the reactor. In this way, crystals that are contained in the outflow are returned to the reactor and the wastewater that is still to be purified is enriched with crystallization seeds. Accordingly, the crystal growth is accelerated which has a positive effect on the economic efficiency of the method.

Furthermore, it is proposed that an anaerobic fermentation process is provided upstream of the method according to the invention. In this fermentation process, nitrogen and phosphorus that are organically bound are decomposed to inorganic water-soluble ions. From these ions, ammonium (NH₄⁺) and phosphate (PO₄³⁻), the phosphate salts, in particular MAP and PMP, can be formed. In this way, nitrogen and phosphate that are bound predominantly on or in organic material or cell mass are converted advantageously into a water-soluble form and are thus available for the production of plant adjuvants. Moreover, in this process biogas is produced which has a significant market value as an energy source.

The method according to the invention operates even better when a partial flow of the outflow of the reactor is supplied to the anaerobic fermentation process. By returning the purified wastewater into the bioreactor, in an advantageous manner the ammonium concentration is kept minimal. An ammonium concentration that is too high in the bioreactor would impair the fermentation process.

Further advantages and advantageous embodiments of the invention can be taken from the following Figures, their description, and the claims. In this connection, all features disclosed in the Figures, their description and the claims can be important for the invention individually as well as in any combination with each other.

It is shown in:

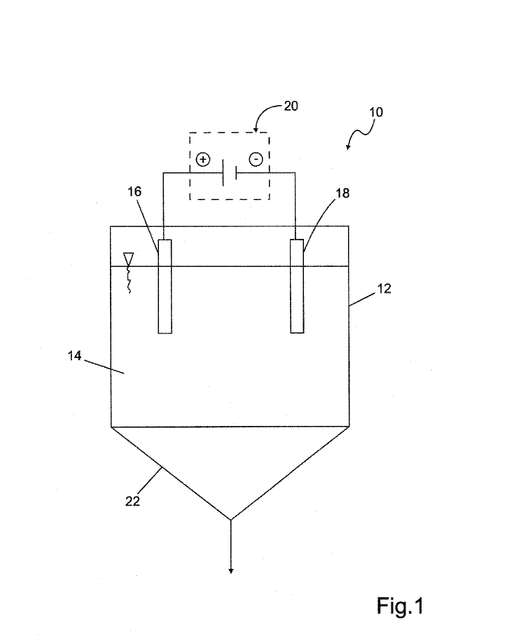

FIG. 1 a process schematic of a method according to the invention for recovering phosphate salts from a phosphate-containing liquid.

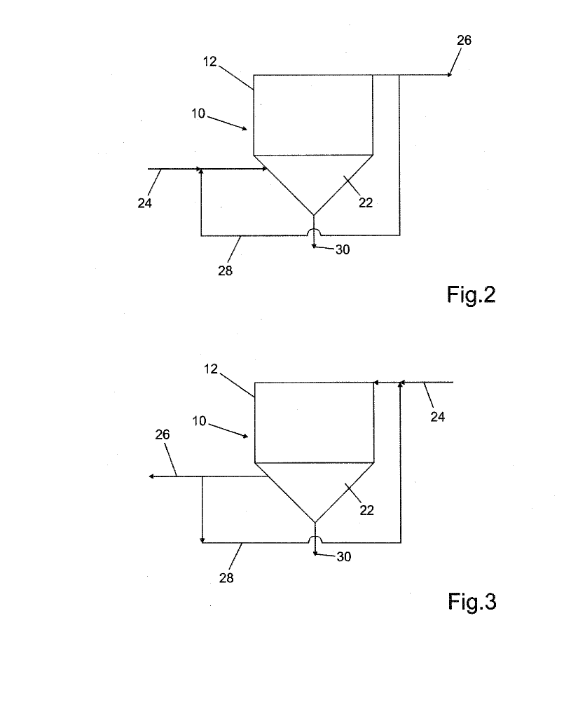

FIG. 2 a schematic illustration of a first embodiment of the method according to the invention for recovering phosphate salts

FIG. 3 a schematic illustration of a second embodiment of the method according to the invention for recovering phosphate salts

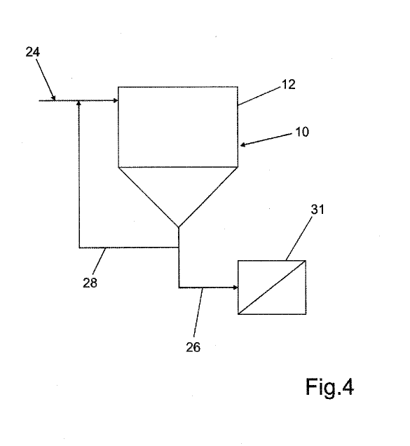

FIG. 4 a schematic illustration of a third embodiment of the method according to the invention for recovering phosphate salts and

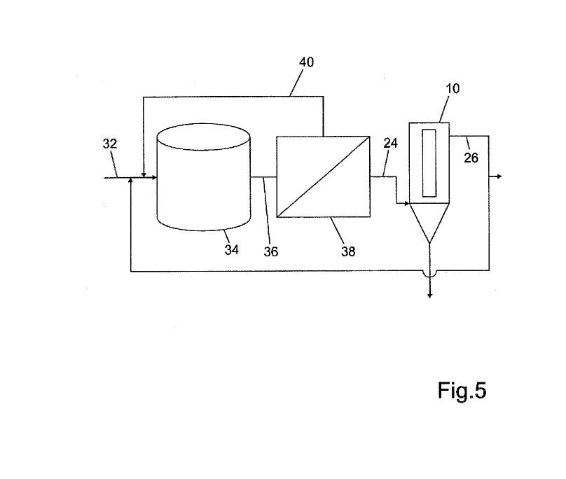

FIG. 5 a schematic illustration of the method according to the invention for recovering phosphate salts with upstream fermentation process

FIG. 1 shows a schematic illustration of a reactor 10 according to the invention. The reactor 10 has a housing 12. The housing 12 serves for receiving a phosphate-containing liquid 14. In the liquid 14 two electrodes 16 and 18 are immersed which are connected with a direct current source 20.

The electrode 16 is a so-called sacrificial anode which is connected with the positive pole of the direct current source 20 while the electrode 18 is a cathode which is connected with the negative pole of the direct current source 20.

The sacrificial anode is comprised of a magnesium-containing material so that magnesium ions end up in the liquid 14 as soon as an electrical voltage is applied to the electrodes 16 and 18.

One embodiment of the method according to the invention proposes an electrolytic operation of the reactor 10. In this connection, the two electrodes 16, 18 are not connected to the external direct current source 20. The magnesium ions are transferred into the solution by the galvanic operation.

The formed phosphate salts are sparingly soluble in aqueous solution and precipitate as crystals which deposit on the preferably conical bottom 22 of the reactor 10. From here they can be removed at any time even during a continuous operation of the reactor 10.

In FIG. 2, the reactor 10 is illustrated. An inlet 24 is arranged laterally at the conical bottom 22. An outlet 26 is located at the top laterally on the housing 12 of the reactor 10. A return line 28 connects the outlet 26 with the inlet 24. At the bottom end of the conical bottom 22 there is a removal device 30.

The phosphate-containing liquid 14 flows through the inlet 24 from the bottom to the top through the reactor 10 and exits through the outlet 26. The precipitated phosphate salts sink downwardly into the conical bottom 22 and are removed via the removal device 30. Through the return line 28, already purified liquid is returned as circulating water to the reactor 10.

FIG. 3 shows a second embodiment of the method according to the invention wherein the reactor 10 is flowed through in downward direction. The inlet 24 is located laterally at the top of the housing 12. The outlet 26 is located laterally at the conical bottom 22. The return line 28 connects the outlet 26 with the inlet 24. At the bottom end of the conical bottom 22 the removal device 30 is arranged.

The phosphate-containing liquid 14 flows through the inlet from top to bottom through the reactor 10 and exits therefrom through the outlet 26. Precipitated phosphate salts are removed via the removal device 30. By means of the return line 28 the already purified liquid is returned to the reactor as circulating water.

FIG. 4 shows a further embodiment of the method according to the invention. Here, the reactor 10 is flowed through in downward direction. The inlet 24 is located laterally at the top of the housing 12. The outlet 26 is located at the bottom end of the conical bottom 22 and extends from there to a downstream filter 31. The return line 28 connects the outlet 26 with the inlet 24.

In this third embodiment of the method according to the invention the precipitated phosphate salts are removed together with the purified liquid from the reactor 10. In the downstream filter, the phosphate salts are separated from the liquid. In this context, there is the possibility of supplying seed crystals to the reactor 10 via the return line 28.

In FIG. 5, an application of the method according to the invention in connection with producing biogas from phosphate-containing wastewater is schematically illustrated.

A wastewater flow 32, organic origin, is supplied to a bioreactor 34. Here, by anaerobic fermentation processes the organic carbon compounds that are contained in the solids are converted into biogas and mineral residual substances. In this process, ammonium-containing and phosphate-containing process water 36 is produced. Before the process water 36 is supplied through inlet 24 to the reactor 10, possibly contained solids 40 are separated in a filter 38. The solids 40 which are retained in the filter 38 are returned into the bioreactor 34. In the reactor 10, in the afore described way, the phosphate salts are separated. The ammonium-containing and phosphate-containing outflow 26 is returned partially into the bioreactor 34. In this way, an impairment of the fermentation process, caused by a high ammonium concentration, is prevented.

What is claimed is:

1.-9. (canceled)

10. A method for complete crystallization, not flocculation, of MAP (magnesium ammonium phosphate) and PMP (potassium magnesium phosphate) from a liquid and recovery of MAP and PMP in a reactor, the reactor equipped with a first group of electrodes and a second group of electrodes, wherein the electrodes of the first group and the electrodes of the second group have different polarity and wherein the electrodes of the first group are sacrificial electrodes that are comprised of a magnesium-containing material; the method comprising:
operating the reactor galvanically;
continuously flowing the liquid through the reactor;
precipitating MAP and PMP from the liquid;
depositing crystals of MAP and PMP in a conical bottom of the reactor; and
removing the crystals via a removal device.

11. The method according to claim 10, comprising the step of automatically adjusting a pH value that is required for precipitating MAP and PMP by formation of hydroxide ions (OH⁻).

12. The method according to claim 11, wherein the pH value is 9.

13. The method according to claim 10, wherein the reactor is flowed through vertically from top to bottom.

14. The method according to claim 10, further comprising the step of separating the crystals in a filter from the liquid.

15. The method according to claim 10, wherein the reactor is flowed through vertically from bottom to top.

16. The method according to claim 10, further comprising the step of returning an outflow of the reactor to an inlet of the reactor.

17. The method according to claim 10, further comprising the step of subjecting the liquid to an anaerobic fermentation process upstream of the reactor.

18. The method according to claim 17, further comprising the step of returning a partial flow of an outflow of the reactor to the anaerobic fermentation process.
